(19) United States
(12) Patent Application Publication
(10) Pub. No.: US 2009/0163837 A1
(43) Pub. Date: Jun. 25, 2009

(54) KNEE FLEXION DEVICES AND METHODS OF USING THE SAME

(75) Inventors: Phillip A. Sanger, Franklin, NC (US); Clifford E. Faull, Sylva, NC (US); Alan Windham, Arden, NC (US); Chip W. Ferguson, Cullowhee, NC (US); George L. Bates, Candler, NC (US); Brant Price, Sylva, NC (US); Cassidy McMahan, Mocksville, NC (US); Dustin L. George, Cullowhee, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Western Carolina University

(21) Appl. No.: 12/327,499

(22) Filed: Dec. 3, 2008

Related U.S. Application Data
(60) Provisional application No. 61/005,153, filed on Dec. 3, 2007.

(51) Int. Cl. A61H 1/02

(52) U.S. Cl. 601/5; 601/33

(57) ABSTRACT

Knee flexion devices and method for using the knee flexion devices are provided. The knee flexion devices include a base member having an elongate body and a tower member extending outward from the base member at a selected predetermined angle. The knee flexion devices further include a foot plate engaging the base member and configured to be movable along the elongate body of the base member.

### RELATED APPLICATIONS

The presently disclosed subject matter claims the benefit of U.S. Provisional Patent Application Ser. No. 61/005,153, filed Dec. 3, 2007; the disclosure of which is incorporated herein by reference in its entirety.

### TECHNICAL FIELD

The subject matter disclosed herein relates generally to a knee flexion device to be used by a patient following total knee replacement surgery. More particularly, the subject matter disclosed herein relates to a knee flexion device designed to exercise and flex the tissue around an artificial knee following total knee replacement surgery.

### BACKGROUND

Each year, over 400,000 total knee replacements are done in the United States. The main reason for this procedure is end stage arthritic changes in an individual's knee. The typical individual undergoing this procedure is in their seventh or eighth decade of life and has been suffering from the effects of arthritic knees in excess of many months and in many cases for years. At best, the majority of these individuals are deconditioned with regard to strength in the lower extremities.

Immediately following knee replacement surgery, a patient begins to heal. Scar tissue forms with healing. The scar tissue is important in the healing process but also can result in significant stiffness in the knee. In early stages, the scar tissue can be stretched and influenced in how it forms. Once scar tissue has matured, it can be very difficult to stretch or release. Typically, scar tissue that is present after six to eight weeks is very difficult for a person to stretch themselves. This tissue can be basically torn loose with manipulation under anesthesia by a surgeon or stretched with more intensive forceful therapy. In most cases, the flexibility that the patient has at 8 weeks is within a few degrees of what they will have permanently. After approximately three months from surgery, even manipulation may not result in the release of scar tissue. It is for this reason that early aggressive therapy is needed. An analogy would be scar tissue being like wet concrete. There is a time where it can be worked and formed into shapes that are desired. Once it is set up, however, there is nothing that can be done with it.

One of the main goals and concerns of total knee replacement is obtaining the maximum amount of motion in the operated knee as quickly as possible in each individual situation.

The standard of care for this procedure is to initiate physical therapy during the first 24 hours following surgery. Many individuals are placed on a continuous passive motion (CPM) machine. This device is designed to slowly, approximately 6-8 cycles per minute, flex and then extend the knee. This is done with the patient in a supine position in bed and the involved extremity cradled at the calf and thigh. The machine will then slowly flex both the knee and hip to the desired amount and then return to extension. Typically, this is begun at a low amount of flexion and gradually advanced over several days. This device is usually continued throughout the hospital stay and is often sent home with the patient for continued therapy. The device works best in the first 90° of flexion and is of limited value past this point.

However, 90° of flexion is far from the desired result from a knee replacement. Most surgeons performing this procedure are not happy with less than 110° of flexion and aim for closer to 125°. It is with further physical therapy, both supervised and unsupervised, that patients are able to realize these goals. However, most individuals do not exceed 90° of flexion at the time of discharge from either the hospital or the rehabilitation facility. It is through their therapy at home that these goals are eventually reached.

Typically, when an individual is discharged, physical therapy is continued as an in-home program with a visiting home health therapist. Eventually, when the patient is more mobile, physical therapy can be outpatient therapy. Many individuals are transferred to outpatient therapy for four to six weeks or longer following their surgery. Most home health therapists will see and treat patients two or three times a week for less than an hour each time. In trying to obtain the desired results, therapy has been limited to a therapist assisting in a range of motion, meaning that the therapist will try to flex the knee for the patient. Alternatively, the therapy involves patients trying to flex their knee on their own. This therapy may involve using the muscles of the involved leg to try to flex the knee. It also may involve attempting to use gravity to help flex the knee or use the opposite extremity with their lower leg hooked in front of the involved leg trying to pull it back. It may also involve sitting on a chair with the foot on the floor trying to slide forward causing the knee to flex. Usually, the only assistive device in this process is a plastic bag on the floor to reduce friction between the foot of the patient and the floor. This reduced friction allows the patient's foot to slide back further thus flexing their knee.

There is usually significant discomfort related to therapy sessions, and especially so when another individual such as a therapist is trying to flex the knee for a patient. The patient's natural response is to tighten up the muscles in the leg to protect the patient from pain. With this natural reflex, it becomes more difficult to bend the knee and the therapist has to push harder. As a result, little progress is gained but significant discomfort produced.

Ordinarily, total knee patients make significant improvement in the first week to ten days while in the hospital or rehab when they are receiving twice a day therapy. However, once they are discharged to their own home, it seems that progress slows down significantly with the twice a week physical therapist involvement.

### SUMMARY

In accordance with this disclosure, knee flexion devices and methods for using the same are provided. It is, therefore, an object of the present disclosure to provide a knee flexion device designed to exercise and flex the tissue around an artificial knee following total knee replacement surgery. This and other objects as may become apparent from the present disclosure are achieved, at least in whole or in part, by the subject matter described herein.

According to an aspect of the present subject matter, a knee flexion device is provided that includes a base member having an elongate body. The knee flexion device also includes a tower member extending outward from the base member at a selectively predetermined angle. The knee flexion device further includes a foot plate engaging the base member and configured to be movable along the elongate body of the base member and configured to be adjustable to the inclination of the foot.

According to another aspect of the present subject matter, a knee flexion device is provided that includes a base member having an elongate body. The base member includes a first end and a second end. The knee flexion device also includes a tower member including a first end and a second end. The first end of the tower member is adjustably secured to the first end of the base member such that the tower member can extend outward from the base member at selectable different angles. The knee flexion device also includes a foot plate onto which a patient can place a foot. The foot plate engages the base member and is configured to be movable along the elongate body of the base member. The knee flexion device further includes a crank disposed on the second end of tower member which creates a mechanical advantage for the patient and assists in flexing the knee. The crank includes a cable that is attached to the foot plate to move the foot plate back and forward along the elongate body of the base member.

According to a further aspect of the present subject matter, a method for using a knee flexion device is provided. The method includes providing a knee flexion device that includes a base member having an elongate body. The base member includes a first end and a second end. The knee flexion device also includes a tower member including a first end and a second end. The first end of the tower member is adjustably secured to the first end of the base member such that the tower member can extend outward from the base member at selectable different angles. The knee flexion device also includes a foot plate onto which a patient can place a foot. The foot plate engages the base member and is configured to be movable along the elongate body of the base member. The knee flexion device further includes a crank disposed on the second end of tower member. The crank includes a cable that is attached to the foot plate to move the foot plate back and forward along the elongate body of the base member. The method includes placing a chair proximal to the second end of the base member. The method also includes rotating the tower member to an appropriate angle. The method further includes sitting a patient in the chair and placing a foot of the patient on the foot plate. The method additionally includes using the crank to move the foot plate from a starting position to a position closer to the patient so that the knee of the patient is flexed.

An object of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates a perspective view of an embodiment of a knee flexion device according to the present subject matter;

FIG. 2 illustrates a side view of a portion of the knee flexion device illustrated in FIG. 1;

FIG. 3A illustrate a perspective view of an embodiment of a knee flexion device showing the direction of movement of a cable used to move a foot plate according to the present subject matter;

FIG. 3B illustrates a close-up perspective view of a portion of the knee flexion device illustrated in FIG. 3A in the general vicinity of the circle 3B in FIG. 3A;

FIG. 3C illustrates a close-up perspective view of a portion of the knee flexion device illustrated in FIG. 3A in the general vicinity of the circle 3C in FIG. 3A

FIG. 3D illustrates a close-up perspective view of a portion of the knee flexion device illustrated in FIG. 3A in the general vicinity of the circle 3D in FIG. 3A;

FIG. 4 illustrates a side view of a portion of an embodiment of a knee flexion device according to the present subject matter;

FIG. 5 illustrates a perspective view of a portion of an embodiment of a knee flexion device having an embodiment of a measuring device to measure the movement of a foot plate according to the present subject matter;

FIG. 6 illustrates a perspective view of a portion of an embodiment of a knee flexion device in a collapsed position according to the present subject matter;

FIG. 7 illustrates a perspective view of a portion of an embodiment of a knee flexion device in an initial extended position according to the present subject matter;

FIG. 8 illustrates a side view of a portion of an embodiment of a knee flexion device according to the present subject matter;

FIG. 9 illustrates a partial vertical cross-sectional view of an embodiment of a hand crank and tower member of an embodiment of a knee flexion device according to the present subject matter;

FIG. 10 illustrates different embodiments of block and tackle systems that can be used with an embodiment of a knee flexion device according to the present subject matter; and

FIG. 11 illustrates a flowchart of a method of use for an embodiment of a knee flexion device according to the present subject matter.

### DETAILED DESCRIPTION

Reference will now be made in detail to the description of the present subject matter, one or more examples of which are shown in the figures. Each example is provided to explain the subject matter and not as a limitation. In fact, features illustrated or described as part of one embodiment can be used in another embodiment to yield still a further embodiment. It is intended that the present subject matter cover such modifications and variations.

To increase the flexibility of a patient's knee following knee replacement surgery, a knee flexion device can be provided that can be used by the patient or a therapist helping the patient to rehabilitate the knee. The knee flexion device allows the patient to stretch scar tissue as it is being formed. It magnifies the patient's own strength and gives a patient feedback as to their progress. This device serves to exercise and flex the tissue around an artificial knee following total knee replacement surgery. The patient has full control during the flexing. The device can give the patient a mechanical advantage of 2-4 times to apply the force to the knee, and the device can be mechanically adjusted to increase the amount of flexure. The amount of flexure is measured and made visible to the patient during the exercise to monitor his/her progress. Further, the device is easily transportable. Using this device, the patient is able to increase the flexure of the knee to 120° of flex which is sufficient to stand up without assistance from a sitting position.

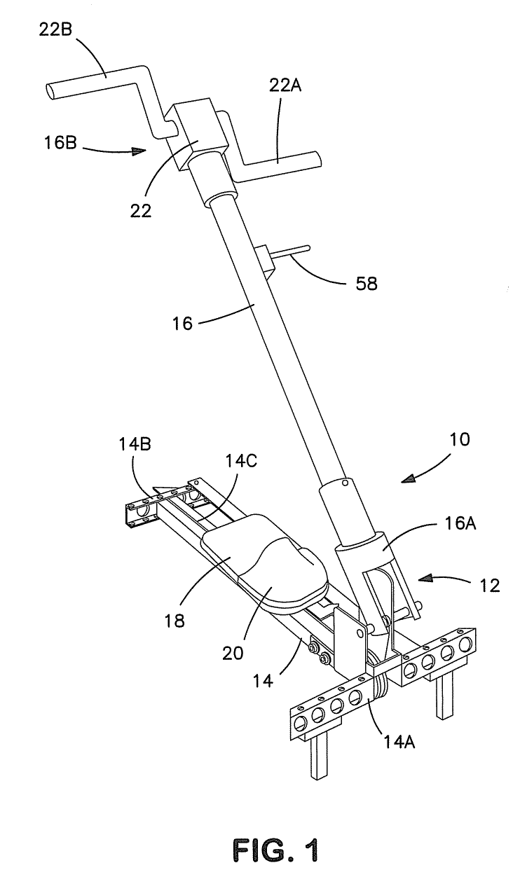

FIGS. 1-9 illustrate a knee flexion device, generally 10, that aids both a therapist and a patient who has undergone knee replacement surgery in stretching scar tissue as it is being formed and to allow the patient to obtain the best result possible with regard to flexion. The knee flexion device 10 includes a lightweight frame 12 having a base member 14 and an articulated tower member 16. The base member 14 can include an elongate body. A foot plate 18 on which the foot of the patient can be placed can engage the elongate base member 14. The foot plate 18 can have a rubber toe boot 20 disposed thereon into which the foot of the patient may be inserted. The foot plate 18 can engage the base member 14 in such a manner that the foot plate 18 glides on the base member 14 of the device 10. For example, the base member 14 can include a track 14C in which the foot plate glides. The foot plate 18 can rotate about a pivot 60 to adjust to the inclination of the foot when the foot plate glides on the base member 14 producing an ergonomically comfortable position. In this manner the foot plate 18 is pivotable to adjust the inclination of the foot plate 18.

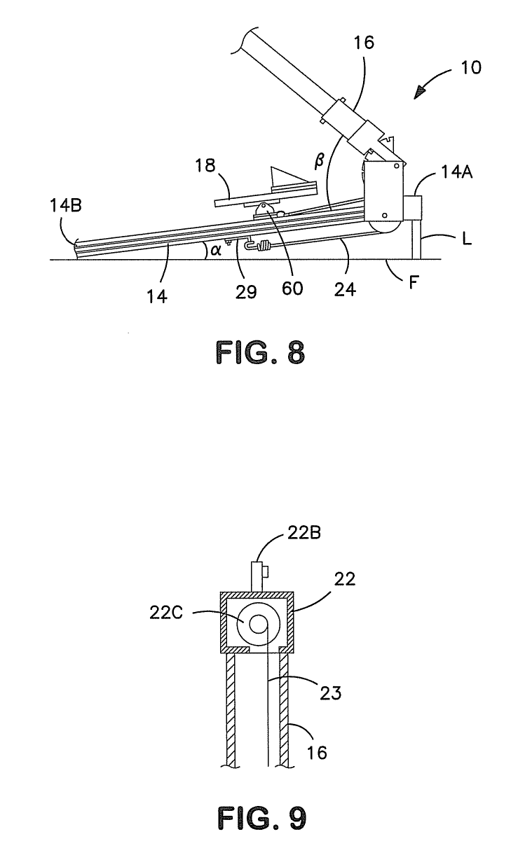

As shown in FIG. 1, the tower member 16 has a first end 16A that is secured to a first end 14A of the base member 14. The first end 16A of tower member 16 can be secured to the first end 14A of the base member 14 at a selectively predetermined angle. For example, the angle can be about 90° or less. For instance, the angle can be an acute angle. At a second end 16B of the articulated tower member 16, a crank 22 can be disposed. The crank 22 can be a hand crank, an electronic crank, a motor, a power device or any device which provides mechanical advantage. In the embodiments shown, the crank 22 is a hand crank. The hand crank 22 can be a double hand crank with a first handle 22A and a second handle 22B dispose on the other side of the hand crank 22 from the first hand crank 22A. As shown in FIG. 9 the hand crank 22 can have a relatively small spool 22C that will wind up a concealed cable 23 that is connected to the foot plate 18.

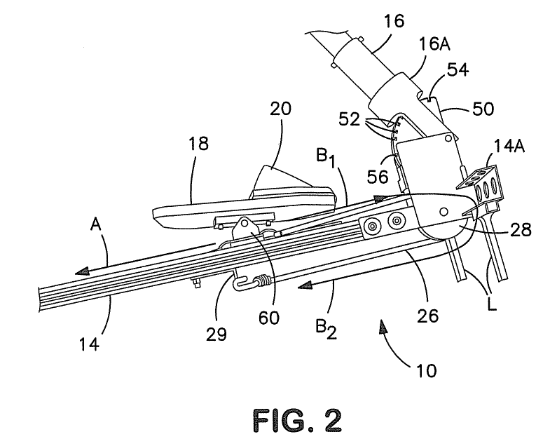

For example, the concealed cable 23 can wrap around the spool and extend down a hollow portion of the tower member 16 (as shown in FIG. 9) and wrap around a pulley or guide located at the juncture of the base member 14 and the tower member 16. The concealed cable 23 can extend down to a second end 14B of the base member 14 and wrap around another pulley or guide and attach to the rear of the foot plate 18. When the hand crank 18 is rotated in an appropriate direction, the spool 22C winds the cable 23 therearound and creates tension in the cable 23. In such an embodiment, as the cable winds onto the spool, the cable can pull the foot plate 18 in a direction A towards the second end 14B of the base member 14 as shown in FIG. 2. The foot plate 18 can be movable between points that are located between the first end 14A and the second end 14B of the base member 14.

As illustrated in FIG. 2, a return mechanism 24 can be secured to the foot plate 18 so that when the tension in the cable 23 is released by releasing or reversing the direction of the hand crank 22, the foot plate 18 returns to the starting position. For example, the return mechanism can be a spring or elastic band. For instance, the return mechanism 24 can be an elastic cord 26, such as a bungee cord, that is attached on a first end to a front portion of the foot plate 18. The elastic cord 26 can extend toward the first end 14A of the base member 14 and can wrap around a pulley 28. The elastic cord 26 can attach at a second end to a stationary position on the side of the base member 14 opposite the side on which the foot plate 18 resides. For example, the second end of the elastic cord 26 can be attached to a permanent and stationary bracket 29 secured to the base member 14.

As tension is created in the cable in the direction A by the winding of the spool, an equilibrium tension is created in the directions B₁ and B₂ in the elastic cord 26. When the tension in the cable is released by reversing the direction of the hand crank 18 to unwind the spool, the tension in the elastic cord 26 pulls foot plate 18 toward its resting or starting position.

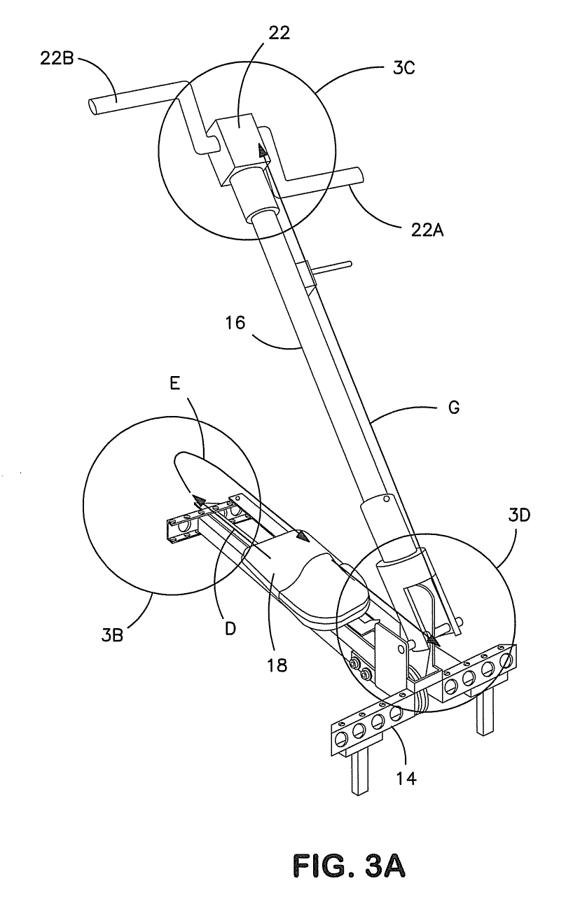

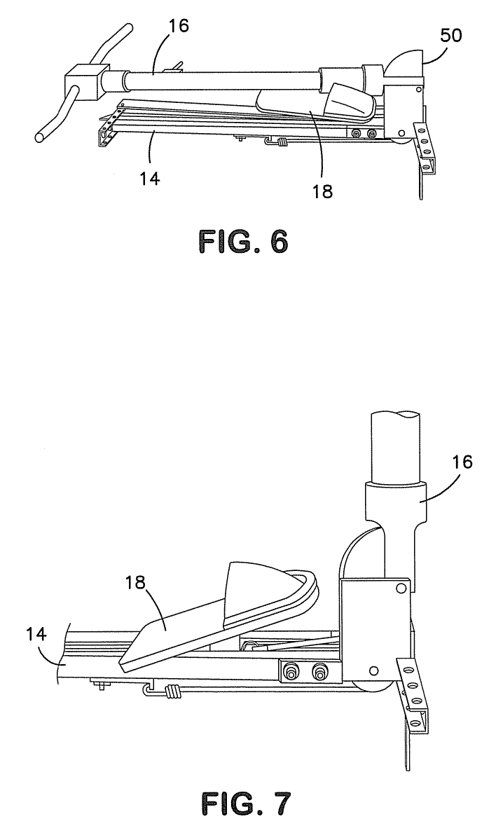

As shown in FIG. 8, the knee flexion device 10 sits with the base member 14 on the floor F in front of the patient who is seated in a straight chair supplied by the patient (not shown). The base member 14 can sit at an angle α as measured from the floor F. For example, the base member 14 can include legs L at the first end 14A where the tower member 16 is secured that make the base member 14 stand at an acute angle to the floor F. The angle α can be an acute angle that provides ergonomic comfort to the patient using the knee flexion device 10. The tower member 16 can extend outward at a selectable angle β from the first end 14A of the base member 14 toward the patient with the hand crank 22 at an easy reaching distance from the patient. The patient sits in the chair and places the forefoot of the involved extremity on the foot plate 18 with the toes in the toe boot 20. The starting position would be with the knee flexed approximately 60° and the foot out in front of the patient. The patient reaches out and operates the hand crank while seated. For example, with the embodiment shown in FIGS. 3A-3D, the patient engages handle 22A of the hand crank 22 with the left hand and engages the handle 22B of the hand crank 22 with the right hand. The patient then rotates the hand crank 22 in a direction to cause the cable to be wind onto the spool. This rotation can be either clockwise or counter-clockwise. For example, the hand crank 22 can be wound in a direction C as shown in FIG. 3C. By using rotation, the effort from the patient is separated from the linear force applied to the patient leg.

The winding of the cable onto the spool pulls the foot plate 18 that is attached to the cable at the rear of the foot plate 18 in the direction D towards the second end 14B of the base member 14 as the cable is pulled in the direction E in the base member 14 and in a direction G up the tower member 16. This pulling by the cable causes the foot plate 18 to slide on the base member 14 toward the patient sitting in the chair causing the knee to flex. There is a mechanical advantage built into the device 10 that will magnify the force needed to rotate the hand crank 22 into a significantly larger force that would slide the foot back toward the patient and flex the knee. This force is a magnified force that the patient would not be able to create on his or her own. The amount of magnification will vary with the size of the crank handles and the size of the spool onto which the cable is wound. For example, the mechanical advantage of the use of the hand crank 22 can be such that the force applied to the flexing of the knee by the knee flexion device 10 can be six times that of the force applied to the hand crank 22.

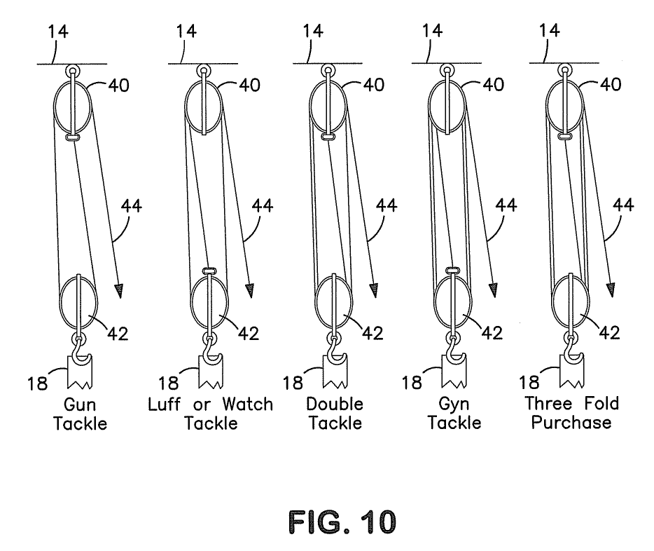

Additional mechanical advantage can be gained by adding a further block and tackle-type of routing of the cable attachment to the foot plate. Examples of possible block and tackle arrangements are shown in FIG. 10 that can be used to increase the mechanical advantage supplied by the knee flexion device 10. A first pulley 40 can be secured to the based member 14 near or at the second end 14B. The second pulley 42 can be secured to the foot plate 18. Each increase in number of loops that the cable 44 makes around the first and second pulleys 40, 42 decreases the force need to move the foot plate by the hand crank. Thus, the more loops the cable 44 makes around the pulleys 40 and 42, the less force is need to rotate the crank to move the foot plate under the same amount of resistance by the patient's leg.

As described above, the return mechanism 24 on the foot plate 18 allows the patient to reverse the direction of the hand crank 22 at any time and the foot will return to the starting position. This feature gives the patient the feeling of being in control and therefore being able to relax and work with the device.

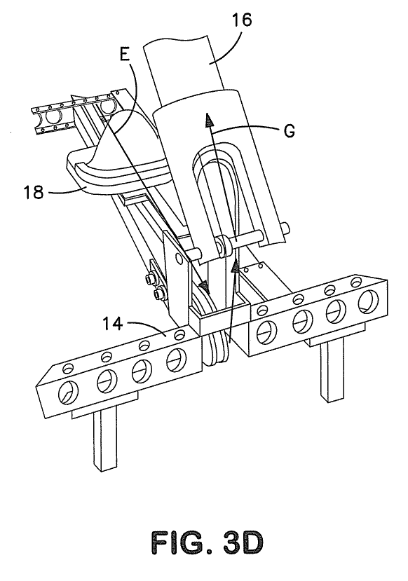

Gauges can be added to the knee flexion device 10 to measure the progress the patient is making with his or her flexibility. Such gauges give them immediate feedback and allow them to set goals and evaluate themselves. For example as shown in FIG. 5, a scale may be attached to the frame 12 along the base member 14 to measure the force being applied in flexing the patient's knee with the knee flexion device 10. Further, a length measuring device 30 can be configured on the knee flexion device 10 to measure the linear distance that the foot plate 18 is moved during use. For example, the length measuring device 30 can include a metering ruler 32 that identifies length measurements along its body. The length measuring device 30 can also include a pointer member 34 that identifies the position of the foot plate 18 along the metering ruler 32 as the foot plate 18 is moved by the hand crank and the return mechanism. Other measuring devices can be used like electronic distance and force measuring devices.

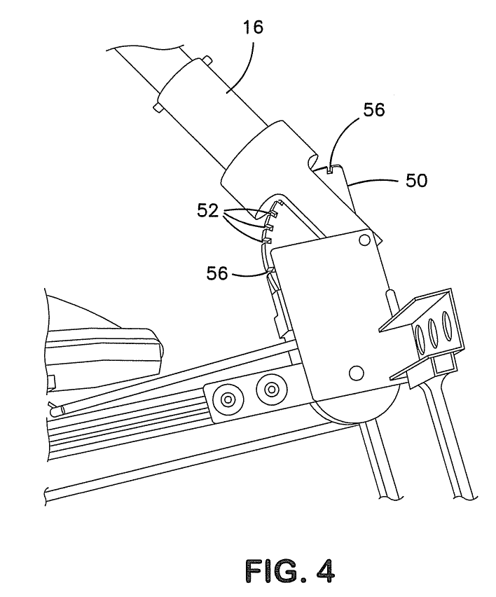

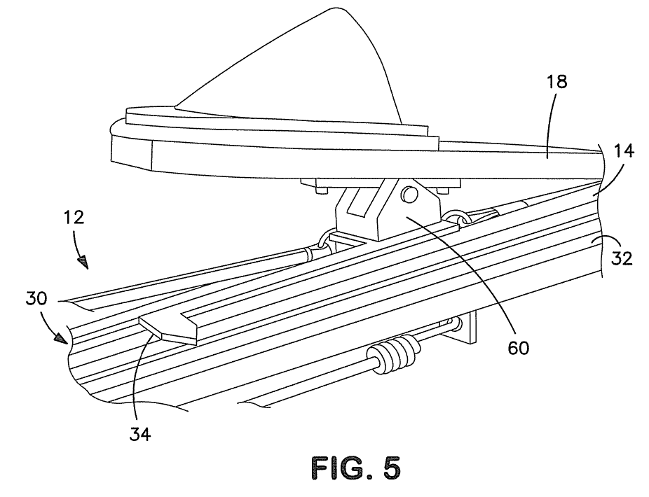

The tower member 16 is rotatably secured to the base member 14. For example, the tower member 16 can be adjustably locked at different angles between about 0° to 5° to about 90° to facilitate use. For example, the tower member 16 can be adjustably locked in an upright position at about 90° as measured from the base member 14 to provide ease of entry of the foot by the patient into the knee flexion device at the beginning of a session as shown in FIG. 7. Further, after use or for storage or transport purposes, the tower member 16 can be folded and adjustably locked in a collapsed position at about 0° that is about parallel to the base member 14 as shown in FIG. 6. Further, the tower member 16 can be adjustably locked into different acute angles as measured from the base member 14 for use by the patient. For example, the tower member 16 can be locked at about 10° intervals between about 80° and about 30°. However, any interval can be used and the intervals do not have to be the same in measurement. The different angles can be provided to accommodate different physical attributes of the patient and different levels of flexibility.

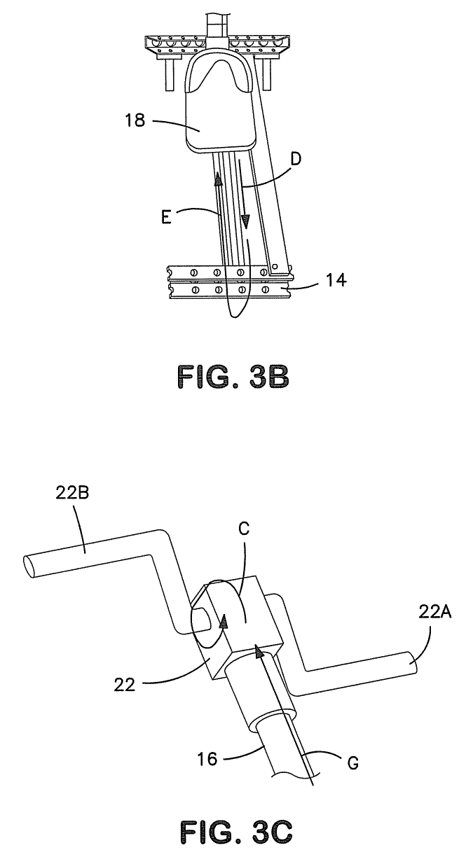

The tower member 16 can be adjustably locked with the base member 14 in different manners. For example as shown in FIGS. 2 and 4, the base member 14 can have a dial plate 50 with dial slots 52 therein that permits the tower member to be movable to different angled positions to suit the patient's physicality and flexibility. The tower member 16 can be forked on the first end 16A such that the first end 16A straddles the dial plate 50. A locking pin (not shown) can reside between the two prongs of the first end 16A of the tower member 16 that can be raised and lowered by a position adjusting handle 58 as shown in FIG. 1. The position adjusting handle 58 can be spring biased toward a lowered position meaning that the locking pin would rest in a lowered position as well. The locking pin will engage a dial slot 52 when in a lowered position to lock the tower member in a specific angled position. The position adjusting handle 58 can be raised to allow the tower member 16 to rotate around the dial plate 50 by disengaging the locking pin from the respective dial slot 52 and holding the locking pin in its raised position. Once the tower member 16 is moved to a desired angle, the position adjusting handle 58 can be released and the locking pin will move to its lowered position once aligned with the nearest dial slot 52.

The dial plate 50 can have special dial slots as shown in FIGS. 2 and 4. For example, a dial slot 54 can be provided that is at a position that will hold the tower member 16 at about 90° to the base member 14. Such a position can be a beginning position for the knee flexion device 10 to increase the ease of entry of the patient into the foot plate 18. Another dial slot 56 can be provided that is at a position that will hold the tower member 16 at about 0° to the base member 14. Such a folded or collapsed position increases the ease of storage and transport of the knee flexion device 10.

The foot plate 18 can ride along a track 14C in the base member 14 that guides the movement of the foot plate 18 and permits it to easily slide back and forth along the elongate body of the base member between points that are located between the first end 14A and the second end 14B. The foot plate 18 can reside on a pivot 60 disposed between the foot plate 18 and base member 14 as shown in FIGS. 5 and 8. The pivot 60 can permit the foot plate 18 to pivot from the toe end to the heel end and vice versa. This pivoting action of the foot plate 18 reduces the stress on the ankle of the patient during use by allowing the foot of the patient to rock as it moves from the starting position to the maximum extension position of the device during use.

The knee flexion device 10 is designed to be relatively safe, inexpensive, simple to use, and effective. It is designed for the patient to use at home immediately following discharge and with little, if any, supervision. The knee flexion device 10 is designed to magnify the patient's own strength and give the patient feedback as to progress being made. By being inexpensive, a larger majority of patients can be provided with the device post operation.

By being simple to use, the knee flexion device 10 allows the patient to use this device two to three times a day with little or no supervision and thus be able to continue the patient's progress at times when the patient is not being seen by a therapist. By being self controlled by the patient, the situation where the patient will tense up as the therapist begins the therapy session because of fear that the therapist would be causing pain or discomfort is prevented. When the patient knows that he or she is in control and can stop or relieve the discomfort immediately, the patient tends to relax and thereby obtain greater benefit.

With the magnification of the input of force by the patient, i.e., the mechanical advantage, the knee flexion device 10 has an increased chance of obtaining the desired effect on flexion of the knee. The knee flexion device 10 can put significantly more flexion force on the knee than current methods being used and therefore can obtain a much better result. By having a positive feedback, the patient can see results and become motivated by results. The feedback can give them a goal and a reward. These techniques are often used by physical therapists but the use of the knee flexion device 10 can occur between therapy sessions increasing the chances of better results.

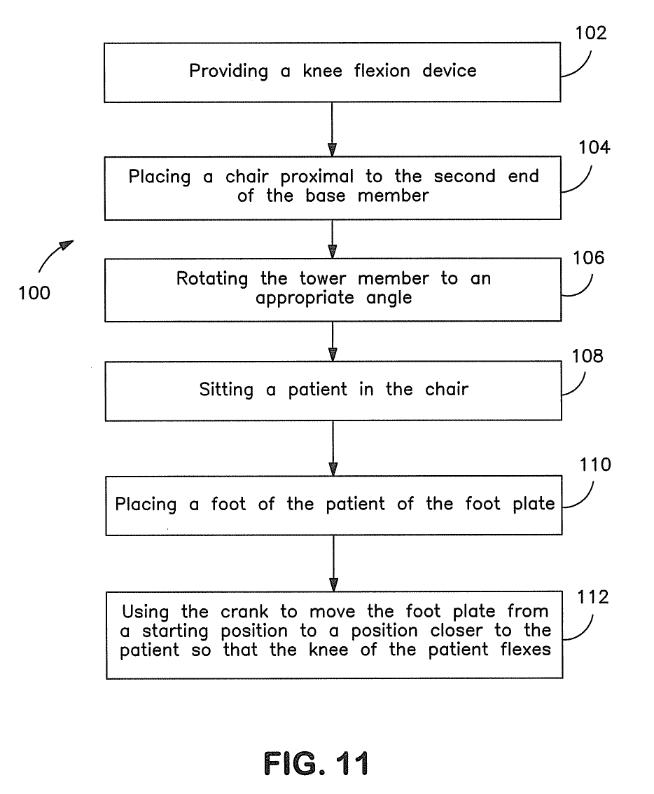

FIG. 11 illustrates a method 100 for using a knee flexion device. In step 102, a knee flexion device as described above is provided. A chair is placed proximal to the second end of the base member in step 104. The tower member can then be rotated to an appropriate angle in step 106. For example, the tower member can be rotated to an initial angle of about 90° to facilitate ease of entry of the foot of the patient. Once the patient has placed the foot on the foot plate, the tower member can be rotated to an acute angle to facilitate use by the patient sitting in the chair. A patient can sit in the chair in step 108 and place his or her foot on the foot plate in step 110. In step 112, the crank can be used to move the foot plate from a starting position to a position closer to the patient so that the knee of the patient flexes. The foot plate can be moved to the starting position when the crank is released. The tower member can be rotated to an initial angle of about 90° to facilitate ease of entry of the foot of the patient.

Embodiments of the present disclosure shown in the drawings and described above are exemplary of numerous embodiments that can be made within the scope of the appending claims. It is contemplated that the configurations of knee flexion devices and the methods of using the same can comprise numerous configurations other than those specifically disclosed. The scope of a patent issuing from this disclosure will be defined by these appending claims.

What is claimed is:

1. A knee flexion device comprising:
a base member having an elongate body;
a tower member extending outward from the base member at a selected predetermined angle; and
a foot plate engaging the base member and configured to be movable along the elongate body of the base member.

2. The device according to claim 1, further comprising a crank disposed on the tower member, the crank includes a cable that is attached to the foot plate to move the foot plate back and forward along the elongate body of the base member.

3. The device according to claim 2, wherein the crank comprises a hand crank.

4. The device according to claim 3, wherein the hand crank comprises a double hand crank.

5. The device according to claim 2, wherein the base member includes a first end and a second end with the foot plate being movable between point that are located between the first end and the second end of the base member.

6. The device according to claim 5, wherein the tower member includes a first end and a second end with the first end of the tower member being secured to the first end of the base member.

7. The device according to claim 6, wherein the tower member is adjustable to different acute angles measured from the base member.

8. The device according to claim 6, wherein the base member includes a dial plate about which the tower member is rotatable, the dial plate including dial slots that are engageable to lock the tower member at different angles.

9. The device according to claim 2, wherein the base member includes a track in which the foot plate glides.

10. The device according to claim 9, wherein the cable is attached to the rear of the foot plate.

11. The device according to claim 9, wherein the crank includes a spool onto which the cable is windable.

12. The device according to claim 11, wherein the cable extends through the tower member and the base member and attaches to the rear of the foot plate.

13. The device according to claim 12, further comprising a first pulley secured at an end of the base member distal from the tower member and a second pulley secured to the rear of the foot plate with the cable threaded around the first and second pulleys in a block and tackle system.

14. The device according to claim 1, wherein the foot plate is pivotable to adjust inclination of the foot plate.

15. The device according to claim 1, wherein the foot plate includes a toe boot.

16. The device according to claim 1, wherein the base member includes legs at an end where the tower member is secured that make the base member stand at an acute angle to the floor.

17. The device according to claim 1, further comprising a return mechanism secured to the foot plate configured to return the foot plate to a starting position after the crank has been use to move the foot plate and the crank is subsequently released.

18. A knee flexion device comprising:
a base member having an elongate body, the base member including a first end and a second end;
a tower member including a first end and a second end, the first end of the tower member being adjustably secured to the first end of the base member such that the tower member extends outward from the base member at selectable different angles;
a foot plate onto which a patient can place a foot, the foot plate engaging the base member and configured to be movable along the elongate body of the base member; and
a crank disposed on the second end of tower member, the crank including a cable that is attached to the foot plate to move the foot plate back and forward along the elongate body of the base member.

19. The device according to claim 18, wherein the base member includes a dial plate about which the tower member is rotatable, the dial plate including dial slots that are engageable to lock the tower member at different acute angles relative to the base member.

20. The device according to claim 18, wherein the base member includes a track in which the foot plate glides.

21. The device according to claim 20, wherein the cable is attached to the rear of the foot plate.

22. The device according to claim 20, wherein the crank includes a spool onto which the cable is windable.

23. The device according to claim 22, wherein the cable extends through the tower member and the base member and attaches to the rear of the foot plate.

24. The device according to claim 23, further comprising a first pulley secured at an end of the base member distal from the tower member and a second pulley secured to the rear of the foot plate with the cable threaded around the first and second pulleys in a block and tackle system.

25. The device according to claim 18, wherein the foot plate is pivotable to adjust inclination of the foot plate.

26. The device according to claim 18, wherein the base member includes legs at an end where the tower member is secured that make the base stand at an acute angle to the floor.

27. The device according to claim 18, further comprising a return mechanism secured to the foot plate configured to return the foot plate to a starting position after the crank has been use to move the foot plate and the crank is subsequently released.

28. A method for using a knee flexion device, the method comprising:
providing a knee flexion device comprising:
(i) a base member having an elongate body, the base member including a first end and a second end;
(ii) a tower member including a first end and a second end, the first end of the tower member being adjustably secured to the first end of the base member such that the tower member extends outward from the base member at selectable different angles;
(iii) a foot plate onto which a patient can place a foot, the foot plate engaging the base member and configured to be movable along the elongate body of the base member; and
(iv) a crank disposed on the second end of tower member, the crank including a cable that is attached to the foot plate to move the foot plate back and forward along the elongate body of the base member;
placing a chair proximal to the second end of the base member;
rotating the tower member to an appropriate angle;
sitting a patient in the chair;
placing a foot of the patient on the foot plate;
using the crank to move the foot plate from a starting position to a position closer to the patient so that the knee of the patient is flexed.

29. The method according to claim 28, wherein the tower member is rotated to an initial angle of about 90° to facilitate ease of entry of the foot of the patient.

30. The method according to claim 28, wherein the tower member is rotated to an acute angle to facilitate use by the patient sitting in the chair.

31. The method according to claim 28, wherein the tower member is rotated to a position about parallel to the base member after use.

32. The method according to claim 28, wherein the crank is a hand crank and the patient operates the hand crank to move the foot plate.

33. The method according to claim 28, further comprising moving the foot plate to the starting position when the crank is released.
